(19) United States
(12) Patent Application Publication
(10) Pub. No.: US 2020/0215730 A1
(43) Pub. Date: Jul. 9, 2020

(54) INSTALLATION FOR PRODUCING COATED PLASTIC COMPONENTS AND MEHTOD THEREFOR

(71) Applicant: EISENMANN SE, Böblingen (DE)

(72) Inventors: Joachim Vogel, Böblingen (DE); Frank Funder, Besigheim (DE); Melitta Lang, Darmsheim (DE)

(21) Appl. No.: 16/647,543

(22) PCT Filed: Sep. 18, 2018
(86) PCT No.: PCT/EP2018/075255

§ 371 Date: Mar. 16, 2020

(30) Foreign Application Priority Data
Sep. 18, 2017 (DE) 10 2017 121 615.4
Nov. 17, 2017 (DE) 10 2017 127 181.3

(51) Int. Cl. B29C 45/00; B29C 64/188; B29C 45/17; B05B 13/04

(52) U.S. Cl. CPC B29C 45/0053; B29C 64/188; B33Y 10/00; B05B 13/0457; B29C 2045/0079; B29C 45/1769

(57) ABSTRACT

An installation and method for producing coated plastic components, having a first plastic manufacturing device and at least a second plastic manufacturing device for producing plastic components and a coating device for the surface coating of plastic components. The coating device has a first coating line which is associated with the first plastic manufacturing device and at least a second coating line which is associated with the first and/or second plastic manufacturing device. The first and/or second plastic manufacturing device is preferably an injection molding device or an additive manufacturing device.

### BACKGROUND OF THE INVENTION

### 1. Field of the Invention

The invention relates to an installation for producing coated components and to a method for producing coated components.

### 2. Description of the Prior Art

For the production of components, such as for example vehicle components—for instance bumpers, radiator grilles, external-mirror shells, etc.—which require a coating for example in the color of the vehicle, use is routinely made of methods such as for instance injection-molding or additive manufacturing, also known as 3D printing. It is often required here that two or more components have to be produced belonging together in different numbers and different sizes. In such a case, they can be produced for example in a batchwise process, that is to say first of all a first batch of the first component and then a second batch of the second component(s) are produced. Alternatively, it is possible to operate in the stated case with two different production machines. In each case, different amounts of components for the respective component type are produced in the same time period.

After the production operation, the components produced by the production machine are first placed manually on product carriers suitable for coating and moved into an intermediate store for buffering. Since it is generally the case that the coating installation can operate continuously and the production machine has to be serviced more frequently, a relatively large number of components are produced first of all. As soon as a sufficient number of components are available for the coating installation to be operated subsequently, the coating operation for this type of components can be started.

A disadvantage with this procedure is that the placement of the components on coating product carriers requires a lot of manual work time, the intermediate buffering of the components requires a correspondingly large-sized buffer store and demands a corresponding waiting time and, moreover, a number of coating product carriers which cannot otherwise be used are stored in the buffer store and additionally have to be regularly rid of the coating.

### SUMMARY OF THE INVENTION

It is an object of the invention to specify an installation for producing coated components and a method therefor which at least alleviate the aforementioned disadvantages and which in particular reduce waiting times, reduce the number of required coating product carriers and help eliminate the need for a buffer store.

These objects are achieved by an installation for producing coated components as claimed in the independent device claim.

The installation according to the invention for producing coated components comprises a first production device and at least a second production device for producing components, for example in additive manufacturing methods and/or by the injection-molding method. Furthermore, the installation comprises a coating device for the surface treatment of components. Such an installation can be for example a painting installation in which a paint layer is applied to the components. This can be for example a wet paint or a powder paint. Of course, other coating types for a suitable surface finishing are also possible.

According to the invention, there is provision that the coating device comprises a first coating line, which is associated with the first production device, and at least a second coating line, which is associated with the second production device. It is possible in this way to solve a number of the aforementioned problems. The assignment of in each case a coating line to at least one production device—in the case of a painting installation, this would be for example a painting line for at least one production device—makes it possible for the phasing of the coating line and of the production devices to be tailored to one another. A combination of two production devices with different phasing and two coating lines which can each be correspondingly adapted in phasing is particularly preferred here. Of course, this concept can also be expanded to a larger number of production devices having at least one coating line or a larger number of coating lines. There can also be provision here that for example two or more coating lines are provided for three or more production devices, or conversely three or more coating lines are provided for two or more production devices, as it were in a matrix arrangement. This can result according to the throughput of the respective device—coating line or production device.

In an advantageous embodiment of the invention, there can be provision that the respective phasing of the first and at least of the second coating line corresponds to the phasing of the associated first and second production device. Different production machines can also be combined with at least one coating line, with the phasing able to be adapted in each case. This decisively reduces waiting or idle times of the overall installation.

In a concrete embodiment of the installation, the first and/or the second production device is an injection-molding device and/or an additive manufacturing device. It is possible here, depending on the requirement, for different combinations of the production types—injection-molding and additive manufacturing—to be performed. The injection-molding device can be primarily designed for the production of plastic components. The additive manufacturing device, also referred to as 3D printing, in the present case represents an operation in which a component is built up on the basis of three-dimensional construction data by, for example, depositing material in layers. Use can be made here of different materials such as metals, plastics and composite materials.

In one embodiment of the installation, one or more production devices are designed as additive manufacturing devices, and the production operation is configured in such a way that a plurality of components emanate from a printing operation and are distributed between at least two coating lines. It is thus possible to utilize the versatility in the production by means of additive manufacturing and different components can be produced in a printing operation. At the same time, the different coatings necessary under certain circumstances for different components can be realized by two or more coating lines.

A smoothing device can advantageously be arranged in an installation between the additive manufacturing device and the coating line. Additive manufacturing devices often operate by means of a buildup in layers of the component to be manufactured. Here, undesired unevennesses can occur on the surface of the component as a result of the buildup in layers. In order nevertheless to achieve a desired smooth surface prior to the subsequent coating, a surface treatment of the produced component can take place for example by annealing, by jetting processes and/or by grinding operations. It is alternatively or additionally possible here for possibly present supporting structures to be removed, edges to be rounded, surfaces to be polished and/or generally prepared for a subsequent coating. These can also comprise operations such as for example suctioning, blowing off, washing, brushing off, a chemical surface pretreatment and/or a plasma treatment.

What are preferably concerned are production methods for producing plastic parts, and the at least one coating line is designed to coat plastic parts.

In an advantageous embodiment of the installation, there can be provision that the first coating line and the at least second coating line share coating device components such as an air supply, an air discharge, a coating material feed, a coating material discharge, a robot, for example for handling and/or surface treatment tasks such as for example coating, ionization, etc., or parts of the coating booth outer casing. Components which can be used jointly thus need to be held available just once for each coating device. This reduces the manufacturing costs of the coating device and thus of the overall installation.

In an advantageous development, the installation comprises an automatic charging device associated with the production devices and intended for charging the components to a coating conveyor system by means of which the components can be conveyed to the coating device and through the respective coating installation. For example, the components can be connected to a coating product carrier, for example by being laid or placed thereon, and can be held by this coating product carrier during part of the subsequent treatment, for example a drying operation. The automated charging device allows further automation of the installation. In collaboration with the phasings of the production devices and of the coating line which can be tailored to one another, there thus result particularly short coating times.

Particularly in an additive manufacturing device it is possible, in addition to the manual removal of the components, to provide an automatic removal of the produced components and the transfer to the charging device by means of a removal robot. Furthermore, separating steps can take place by means of such a robot or a further robot, for example assisted by an image recognition device. A transfer between individual treatment stations can occur with the aid of suitable handling stations, such as for example multi-axis robots with suitable grippers or by means of suitable conveying devices.

A particularly advantageous installation is obtained if a charging device is arranged in each case between at least one production device and at least one associated coating device. This allows particularly simple and exact tailoring of the respective phasing of the production devices with the coating lines.

In a likewise advantageous development, the installation comprises a device for temperature control of the components, wherein the temperature-control device is arranged upstream or downstream of the coating device. A temperature control, such as for example a heating of the components and/or a cooling, can therefore occur in a downstream production step.

It can be advantageous in this connection if a transfer device for transferring the components from the coating product carrier to a temperature-control product carrier is arranged between the coating device and the temperature-control device. Here, the transfer device can for example supply only one coating line or both coating lines and thus transfer the components to a product carrier which is suitable for temperature control.

Alternatively, a coating product carrier can be provided for the components, and a transfer device for transferring the components with the coating product carrier from the coating conveyor system to a temperature-control conveyor system can be arranged between the coating device and the temperature-control device.

The transfer of a component together with the coating product carrier has the advantage on the one hand that no transfer of the coated component from the coating product carrier to another product carrier has to occur between the coating device and the temperature-control device. The risk of damage to a possibly still not completely fixed coating or for example to a still shock-sensitive coating is reduced. On the other hand, it is possible for example by using appropriate receptacles, such as for example painting or drying frames, for the coating product carriers to achieve a reduction in that amount of material which has to be cleared again in particular after coating and temperature control.

The object is also achieved by a method for producing coated components as claimed in the independent method claim.

The method according to the invention comprises the following steps: producing a first component using a first production device; producing a second component using a second production device; charging the components to a conveyor system, for example with product carriers; conveying the first components, for example on the product carriers, by means of the conveyor system through a first coating line of a coating installation and coating the components in the at least one coating line; conveying the second components, for example on the product carriers, by means of the conveyor system through the first or a second coating line of the coating installation and coating the components in the first or second coating line.

The first and/or second production device can be for example an injection-molding device and/or a device for additive manufacturing. The components are for example plastic components, in particular injection-molded components and/or plastic components produced by additive manufacturing.

For the case of additive manufacturing devices, the coating can be preceded by a surface treatment in the sense of a smoothing of the production-related surface unevennesses or cleaning of the components. This can comprise the use of temperature-controlled processes, abrasive treatment processes, chemical surface treatment and/or physical methods such as for example a plasma treatment. The production of a component and the associated coating of the component can advantageously be tailored to one another in terms of time in such a way that no intermediate storage of the component has to occur.

The additive manufacturing of components instantaneously requires, for comparable component sizes and geometries, a longer production time than other production methods such as for example injection-molding. A plurality of production devices are therefore required for a comparable component flow in order to equip a coating line which is geared for another production method and the associated component flows. Depending on the type of the components to be produced, it is also possible to combine different production methods so as to optimally utilize an existing coating line and avoid unnecessary idle times.

In one embodiment of the invention, there can be provision that an in-mold painting method is used in an injection-molding machine and/or the basic color of the component varies during the additive manufacturing, that is to say that a basic color of the component can be determined already during the manufacturing. The associated coating lines for a subsequent coating of such a component then serve for finishing/enhancing the produced surfaces which already have the desired coloring.

Furthermore, the coating of the components can be preceded or followed by a temperature control or a flashing-off or curing of the components or of the coating produced on the components.

The advantages of the invention can thus also be realized in the context of a method.

There is thus provided according to the invention a coating line, such as for example a painting line, per injection-molding machine and/or at least one additive manufacturing device (3D printer). The phasing of the respective coating line is tailored to the phasing of the injection-molding machine or the 3D printer. The handling occurs only automatically. There is no buffer between the injection-molding machines, the 3D printers and the coating lines. In the coating line, the transport element can be changed upstream of the dryer/oven. The components are then automatically transferred from coating product carriers to dryer product carriers after flashing-off. The latter are on the drying frames. There thus result at least two product transport holder circuits, at least one for the coating per se and at least one for the dryer/oven and optionally a subsequent further processing, for example in the assembly.

Since there are no or only small intermediate stores from the injection-molding machines and/or additive manufacturing machines to the coating lines, the number of the individual coating product carriers (to be stripped of paint) can be reduced, including the number of associated coating frames to which the product carriers can be fastened for a conveying operation.

### BRIEF DESCRIPTION OF THE DRAWINGS

Exemplary embodiments of the invention are explained in more detail below with reference to the drawings, in which:

FIG. 1 shows in a schematic illustration a first embodiment of an installation for producing plastic components;

FIG. 2 shows in a schematic illustration a second embodiment of an installation for producing plastic components; and

FIG. 3 shows in a flow diagram an exemplary embodiment of a method according to the invention.

### DESCRIPTION OF PREFERRED EXEMPLARY EMBODIMENTS

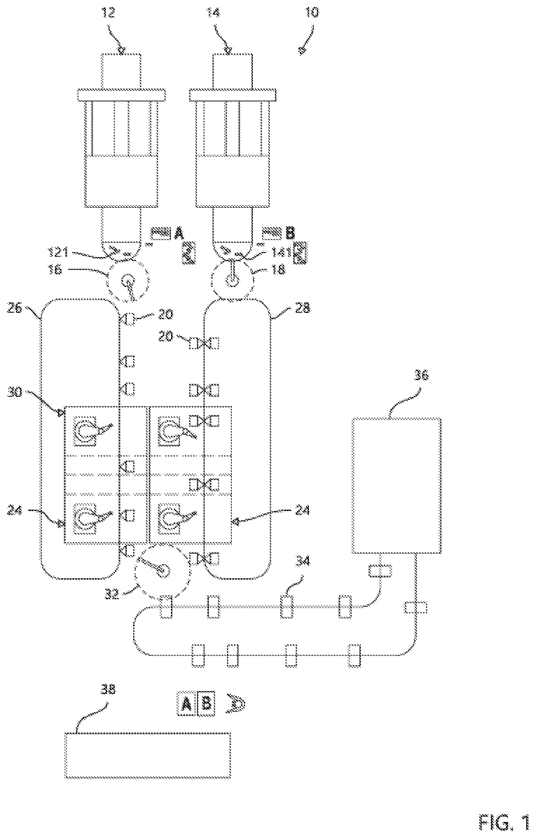

FIG. 1 illustrates in a schematic illustration a first embodiment of an installation 10 for producing plastic components, such as for example vehicle components (bumpers, radiator grilles, exterior-mirror shells, etc.). In the embodiment shown in FIG. 1, the installation 10 comprises two injection-molding machines, namely a first injection-molding machine 12 and a second injection-molding machine 14, which are only indicated schematically. The injection-molding machines 12, 14 inject a liquefied plastic under pressure into an injection mold. The plastics can be for example thermoplastics, thermosets or elastomers. In the present case, the two injection-molding machines 12, 14 are illustrated as structurally identical machines. It is also conceivable that the one injection-molding machine has a different structure and optionally also a different throughput than the other injection-molding machine. Alternatively, the machines in question can be machines for additive manufacturing instead of injection-molding machines. It is also possible for injection-molding machines and machines for additive manufacturing to be present jointly in the installation. On account of the different production times, more than two machines for the additive manufacturing of plastic components can also be provided.

As denoted in the figure by the letters A and B, the first injection-molding machine 12 produces plastic components 121 of a first type A, and the second injection-molding machine 14 produces second plastic components 141 of a second type B. It can be the case here that the first type A differs from the type B in shape, size, nature or some other way. However, it can also be the case that both types A and B are identical, but the throughput of the two injection-molding machines 12, 14 differs.

A setup with two injection-molding machines 12, 14 is shown in the present embodiment of the installation 10. It is also conceivable within the context of the present invention to provide more than two injection-molding machines for two or more coating lines.

It is also possible, as already mentioned, to provide additive manufacturing devices instead of the injection-molding machines or else together with injection-molding machines. Particularly when combining the two production technologies (injection-molding/additive manufacturing), the highly different production rates can be taken into consideration by the provision of two or more coating lines without having to provide additional buffering. Thus, the different component parts for a component can be produced with different production technologies and divided between the respective associated coating lines corresponding to the different production rates.

Each of the two injection-molding machines 12, 14 is assigned a charging device 16, 18. The charging devices 16, 18 take the plastic components 121, 141 produced by the injection-molding machines 12, 14 and place them on coating product carriers 20. In the present case, structurally identical coating product carriers 20 are provided both for the plastic components 121 of the first injection-molding machine 12 and for the plastic components 141 of the second injection-molding machine 14. However, it could also be the case that, on account of the nature of the respective plastic component, different coating product carriers have to be used.

The charging devices 16, 18 operate automatically, are phased with the respective injection-molding machine 12, 14 and generally require no operator attendance. Particularly in additive manufacturing, the charging devices 16, 18 can also perform separating operations, where appropriate by means of image recognition. Each charging device 16, 18, and thus also in the present embodiment each injection-molding machine 12, 14, is assigned a coating installation 30 in the form of a painting line 22, 24 which are each charged by means of a transport device 26, 28 with the coating product carriers 20 (which carry produced injection-molded components 121, 141).

The painting lines 22, 24 are part of a painting installation 30 and can be set up and phased independently of one another. The painting lines 22, 24 can thus be adapted to the respective requirements of the associated injection-molding machines 12, 14 and the corresponding plastic components 121, 141. The steps required for coating the plastic components, such as for example deflashing, grinding, cleaning, pretreating, coating, flashing-off, repeated coating, etc., will be carried out in the painting installation 30. The pretreatment can in particular also comprise the smoothing of the surface, as may be necessary in particular after additive manufacturing, with the aforementioned methods, or the additional cleaning after the additive manufacturing steps or after the smoothing in order to create a clean surface with optimal adhesion properties for the subsequent coating.

It is possible here, depending on the throughput, to carry out manual or automated handling processes, for example with the use of painting robots, and, where appropriate, also inspection/audit or function-checking processes.

The painting lines 22, 24 can be designed to be completely separated from one another and can be controlled and operated separately from one another. However, there can advantageously also be provision that the two painting lines 22, 24 have components which can be used jointly. For example, the painting lines 22, 24 can have a common air-conditioning, a common energy supply or a common painting material supply and, where appropriate, can also be correspondingly jointly activated.

In the presently shown embodiment, after running through the painting installation 30 the transport devices 26, 28 are coupled to a common transfer means 32 which carries out a transfer of the plastic components 121, 141 to temperature-control product carriers 34. The temperature-control product carrier can be for example an individual product carrier for the individual component. The product carriers can then additionally be placed on painting frames. The use of product carriers offers the advantage that the coating product carriers 20, for example still before fixing by heating of the coating applied in an undesired manner, can be cleaned, for example stripped of paint, in a considerably simpler manner.

The coated plastic components 121, 141 are fed to an oven 36 by means of the temperature-control product carriers 34 and a corresponding conveying system. The plastic components 121, 141 are subjected to a temperature-control step in the oven 36, this step causing the coating to be fixed, for example by heating. Additionally or alternatively, it is of course also possible to carry out other further-processing steps after running through the painting lines 22, 24. This is symbolically illustrated in FIG. 1 by the further-processing station 38.

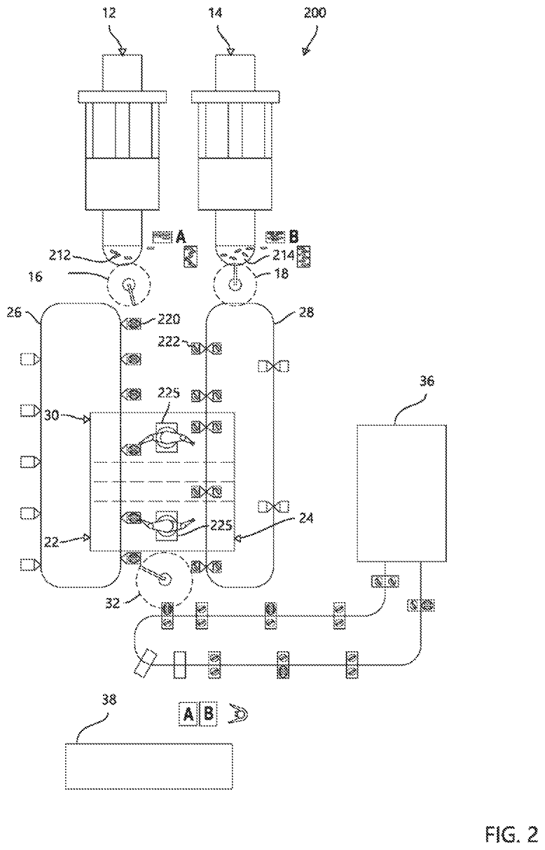

FIG. 2 illustrates in a schematic illustration a second embodiment of an installation 200. In order to avoid repetitions, features of the installation 200 which are identical or comparable to features of the installation 10 described in relation to FIG. 1 are not explained separately again and are designated by the same reference signs.

The installation 200 is likewise designed for producing plastic components and likewise comprises two injection-molding machines 12, 14 which produce plastic components 212, 214. The plastic components 212, 214 are charged by means of charging devices 16, 18 to transport devices 26, 28. By contrast to the embodiment of FIG. 1, the plastic components 212, 214 are connected, for and during transport, to product carriers 220, 222 over a plurality of work steps. The connection can be established for example by laying on, plugging on, suspending, gluing on, screwing on, etc. As can be gathered from FIG. 2, the plastic components 212, 214 remain connected to the product carriers 220, 222 even after the coating operation and transfer from the conveying system 26, 28, which conveys them toward the painting installation 30 and through the painting installation 30, to the conveying system which conveys the plastic components 212, 214 to the oven 36.

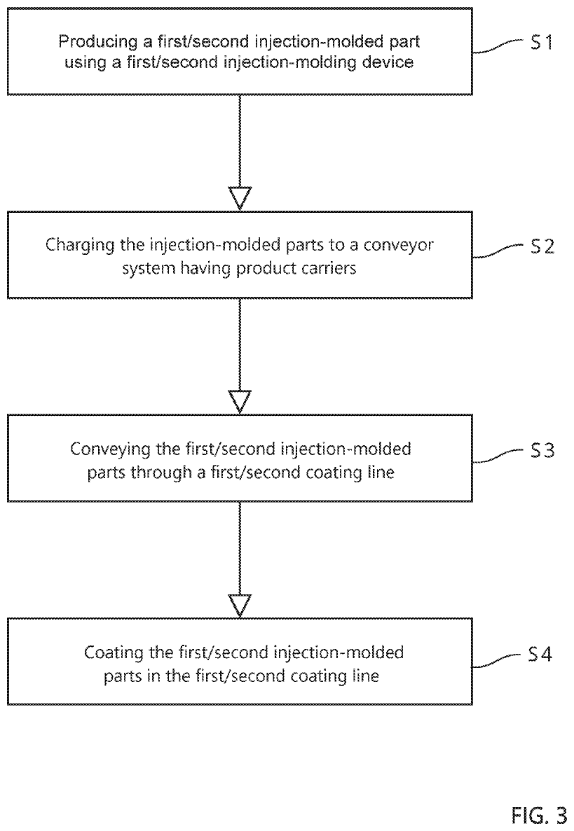

FIG. 3 illustrates an exemplary method according to the invention in a flow diagram. The method provides the following steps:

A first injection-molded part is produced using a first injection-molding device, and a second injection-molded part is produced using a second injection-molding device (S1). The separate production of the injection-molded parts with separate injection-molding devices allows for example a separate phasing for different components. Instead of one of the two injection-molding devices, additive manufacturing devices can also be present for the production of components.

In a subsequent step (S2), the injection-molded parts/components are charged to a conveyor system with product carriers. The conveyor system is designed to convey the first injection-molded parts/components on the product carriers through a first coating line of a coating installation and the second injection-molded parts/components on the product carriers through a second coating line (S3).

Coating of the respective injection-molded parts/components occurs in the respective coating line (S4).

What is claimed is:

1. An installation for producing coated plastic components, comprising:
a) a first plastic production device and at least a second plastic production device for producing plastic components;
b) a coating device for the surface coating of plastic components; wherein
c) the coating device comprises a first coating line, which is associated with the first plastic production device, and at least a second coating line, which is associated with the first and/or the second plastic production device.

2. The installation as claimed in claim 1, wherein the respective phasing of the first coating line and at least the second coating line corresponds to the phasing of the associated first plastic production device and the second plastic production device.

3. The installation as claimed in claim 1, wherein the first plastic production device and/or the second plastic production device is an injection-molding device or an additive manufacturing device.

4. The installation as claimed in claim 3, wherein a smoothing device is arranged between the first plastic production device or the second plastic production device and the coating line and the first coating line and/or second coating line.

5. The installation as claimed in claim 1, wherein the first coating line and at least the second coating line share coating device components.

6. The installation as claimed in claim 1, further comprising an automatic charging device which is associated with the first plastic production device and the second plastic production device, the automatic air charging device intended for charging the plastic components to a coating conveyor system by means of which the plastic components can be conveyed to the coating device and through the coating device.

7. The installation as claimed in claim 6, wherein a charging device is arranged in each case between each plastic production device and an associated coating device.

8. The installation as claimed in claim 1 further comprising a device for temperature control of the plastic components, wherein the temperature-control device is arranged downstream or upstream of the coating device.

9. The installation as claimed in claim 8, wherein a transfer device for transferring the plastic components from a coating product carrier to a temperature-control product carrier is arranged between the coating device and the temperature-control device.

10. The installation as claimed in claim 8, further comprising an automatic charging device which is associated with the first plastic production device and the second plastic production device, the automatic air charging device intended for charging the plastic components to a coating conveyor system by means of which the plastic components can be conveyed to the coating device and through the coating device wherein a coating product carrier is provided for the plastic components, and a transfer device for transferring the plastic components with the coating product carrier from the coating conveyor system to a temperature-control conveyor system is arranged between the coating device and the temperature-control device.

11. A method for producing coated plastic components, comprising the following steps:
producing a first plastic part using a first plastic production device;
producing a second plastic part using a second plastic production device;
charging the plastic parts to a conveyor system;
conveying the first plastic parts by means of the conveyor system through a first coating line of a coating installation and coating the plastic parts in the first coating line; and
conveying the second plastic parts by means of the conveyor system through a second coating line of the coating installation and coating the plastic parts in the second coating line.

12. The method as claimed in claim 11, wherein the production of a plastic part and the associated coating of the plastic part are tailored to one another in terms of time in such a way that no intermediate storage of the plastic part has to occur.

13. The method as claimed in claim 11, wherein the coating of the injection-molded parts is followed by a temperature control of the injection-molded parts.

14. The installation as claimed in claim 5, wherein the coating device components shared by the first coating line and at least the second coating line include or more of an air supply, an air discharge, a coating material feed, a coating material discharge, a robot for handling and/or surface treatment tasks, or parts of the coating booth outer casing.
